(19) United States
(12) Patent Application Publication
(10) Pub. No.: US 2006/0205349 A1
(43) Pub. Date: Sep. 14, 2006

(54) Apparatus and method for wireless audio network management

(75) Inventors: Chris Passier, Kanata (CA); Ralph Mason, Ottawa (CA); Brent Allen, Manotick (CA)

Correspondence Address: CASSAN MACLEAN, 80 ABERDEEN STREET, SUITE 401, OTTAWA, ON, K1S 5R5, CA

(73) Assignee: ENQ SEMICONDUCTOR, INC.

(21) Appl. No.: 11/073,689

(22) Filed: Mar. 8, 2005

(51) Int. Cl. H04B 7/00; H04M 1/00

(52) U.S. Cl. 455/41.2; 455/575.2

(57) ABSTRACT

Electronic apparatus and method are provided for management of communications between channel master (e.g. audio player), responding device (e.g. remote control/headphones) and, optionally, passive devices (e.g. headphones) wirelessly connected in a wireless audio network. The channel master transmits, and the responding device receives, audio signals and network management information. Profile negotiation means communicates application profiles for the devices, establishing at least one application profile which is common to them and designating a selected, common application profile for use in associating the devices. Channel selection means selects a channel for the communications using an ordered selection of channels (PCS) obtained from scanning the channels for idle channels and ordering the scanned channels according to priority based on channel quality. Normalized control and status interfaces establish interoperability between devices which use different data streams to communicate in the network.

### FIELD OF THE INVENTION

The invention relates to means for managing different types of audio devices (for example, an MP3 player with its associated remote control and/or headphone set(s), or a home theatre system with its associated speakers and/or remote control) in a wireless audio network.

### BACKGROUND OF THE INVENTION

The use of private/home wireless networks for connecting audio systems is increasing and, along with this increase, so is the need for efficient (low power) means for managing the communication flow between a number of different networked devices.

A simple wireless audio network might, for example, contain just two devices, namely, at one wireless endpoint, an audio player from which a unidirectional stream of audio data is transmitted (referred to as the audio source) and, at another wireless endpoint, an audio remote control (referred to as the audio sink) which returns packets containing key-press information. Yet another example, designed to advantageously exploit the nature of the wireless network, might be to add a number of separate audio remote/headphone sink devices to the foregoing two-device network which can then “listen in” to the audio data transmitted from the audio player. As such, the network users are able to securely share their audio material (e.g. music) amongst each other.

The advantages of private/home wireless networks are evident and means for enabling optimum usage of such networks is in increasing demand. Also increasing are the number of different models (and features), and manufacturers, of wireless audio devices which interferes with, and complicates, any ability to uniformly manage such devices. Each different device may use a different (manufacturer-dependent) data stream to communicate its associated commands or controls to other devices in the network and, consequently, in order for communications in such networks to succeed, there is a need for effective means to establish interoperability of the different devices within the network. There is also a need for effective means to introduce a device into the network and for different devices to find (detect) one another, such as upon the power-up of one or more such devices.

Adding to this challenge, is the limited availability of power and bandwidth that can be used to achieve these desirable functions within a wireless audio network. Therefore, there is a need for wireless audio network management means which minimizes the requirements for processing power, logic and bandwidth.

### SUMMARY OF THE INVENTION

The inventors have developed low-power, efficient and effective means for managing wireless audio networks. In accordance with the invention there is provided an electronic apparatus and method for management of data communications between at least two devices wirelessly connected in a wireless audio network (which may be a digital audio network). The data comprises audio signals and audio control commands and/or status information. A first device acts as a channel master and a second device acts as a responding device associated with the channel master, each device having a unique association identifier (AID) and an application profile identifying at least one class and one or more capabilities for the device. Profile negotiation means comprises means for communicating the application profiles for the devices between the first and second devices, means for establishing at least one common application profile which is common to the devices and means for designating a selected common application profile (PIU) for use in associating the devices. The profile negotiation establishes interoperability between the devices in the network. Active association means, for associating the first and second devices before the data communications, detects an active association trigger occurring concurrently in each device and exchanges between the devices their AID's and the PIU.

Channel selection means selects a channel for the communications. First selection means embodied in the first device scans (e.g. for energy) channels of the network for idle channels, establishes from the scanning an ordered selection of the channels (PCS) and communicates the ordered selection of channels (PCS) to the associated second device. Second selection means embodied in the first device selects a first available channel from the ordered selection of channels (PCS) and transmits beacon signals from the first device over the selected first available channel wherein the beacon signals comprise the unique association identifier (AID) of the first device. Third selection means embodied in the second device scans channels in the order of the ordered selection of the channels (PCS) and identifies, for use by the second device, the selected channel of the first device from the scanning and detection of the transmitted beacon having the unique association identifier (AID) of the first device.

Control and status interfaces normalize the audio control command and status information for communicating same between the devices, so as to establish interoperability between the devices, including those configured for communicating data streams which are incompatible prior to the data normalization.

The application profile for each device may include one or more optional capabilities of the device, such as audio control commands. The channel master may be configured for transmitting the audio signal with the responding device configured for receiving the audio signal. Alternatively, the channel master may be configured for transmitting and receiving the audio signal with the responding device configured for receiving and transmitting the audio signal, respectively. The network may include an additional wireless device (or devices) configured to act as a passive device and be passively associated with the first device. Passive association means detects a first passive association trigger in the associated second device and a concurrent second passive association trigger in the passive device and communicates the AID of the first device to the passive device.

The first device may be an audio source such as an audio player (e.g. compact disc (CD) player, MP3 player or mini-disk player) and the second device may be an audio sink such as a remote control and headphones. Or, for another application, the first device may be a cell phone handset and the second device a cell phone headset. Further, the first and second devices may be separate items from, and connectable to, an audio source and an audio sink, respectively, the audio source configured for communicating the data to the first device and the first device configured for communicating the audio control commands and/or status information to the audio source and the audio sink configured for communicating the audio control commands and/or status information to the second device and the second device configured for communicating the data to the audio sink.

The ordered selection of channels (PCS) may be ordered in subgroups according to channel quality, each channel of one the subgroups being considered to be of like quality to other the channels of the subgroup determined on the basis of a likelihood of the channels of the subgroup to experience interference and/or on the basis of a likelihood of the channels to be occupied. Also, the order of the channels of each the subgroup may be randomized.

Upon pre-determined events, the first selection means may re-establish the ordered selection of the channels (PCS) and communicate the same to the associated device. Pre-emptive, hop-and-scan means may be provided in the second device for periodically scanning the next channel in the ordered selection of channels (PCS) (i.e. the channel after the selected channel of the first device), for determining next channel scan information therefrom and for communicating to the first device that next channel scan information, with the first device comprising means for removing that next channel from the ordered selection of channels (PCS) if the first device considers that it is not idle based on that next channel scan information.

### BRIEF DESCRIPTION OF THE DRAWINGS

An exemplary embodiment of the invention is described in detail below with reference to the following drawings in which like references refer to like elements throughout:

FIG. 1 is a functional block diagram of the hardware, on a semiconductor chip, of a wireless audio network system in which the network management processes of the present invention are incorporated;

FIG. 2 is a block diagram of the software functional layers of said network system;

FIG. 3 is a block diagram of the configuration of a portable audio player application of said system;

FIG. 4 is a block diagram of the configuration of a portable audio remote control/headphone application of said system;

FIG. 5 is a pictorial illustration of one example of a wireless audio network comprising an audio player (source device) and three (two of which being passively) associated wireless remote/headphone sets (sink devices);

FIG. 6 is schematic illustration of a wireless audio network in which a channel master manages the flow of communications between the audio devices within the network;

FIG. 7 is a block diagram illustration of three Transport Superframes (TSFs) of a notional stream of communications data in a managed wireless audio network in accordance with the invention;

FIG. 8 is a schematic diagram illustrating an endpoint-to-endpoint communications sequence for profile negotiation between source (player) and sink (remote control/headphone) devices during the process of association of those devices in a wireless audio network in accordance with the invention;

FIG. 9 is a further schematic diagram illustrating an exchange of messages between source and sink devices (acting as channel master and responding device, respectively) during the process of active association and profile negotiation in a wireless audio network in accordance with the invention;

FIG. 10 is a pictorial illustration of an audio network comprising a source player and associated remote control/headphone sink device, in which passive association of a further remote control/headphone device is requested in order that the further device can listen in on the audio transmission of the player;

FIG. 11 is a schematic diagram illustrating an exchange of messages between the player, associated sink device and passive sink device shown in FIG. 10 during the process of passive association in a wireless audio network in accordance with the invention;

FIG. 12 is a chart depicting the preferred channel sequence (PCS) priority definition applied by the network management apparatus and process of the invention;

FIG. 13 illustrates the maximum required scan period for a sink device in a wireless audio network incorporating the present invention to find its channel master;

FIG. 14 is a block diagram illustration of the control and status interfaces (AKEY and ACSI) used by a network management apparatus and method according to the invention;

FIG. 15 illustrates the make-up of a generic ACSI frame;

FIG. 16 illustrates the format of an ACSI frame control field (byte);

FIG. 17 illustrates the format of an ACSI type-identifier field (byte);

FIG. 18 illustrates the format of an ACSI control frame; and,

FIG. 19 illustrates the format of an ACSI status frame.

### DETAILED DESCRIPTION OF AN EMBODIMENT OF THE INVENTION

The inventors have invented and developed new and effective means for achieving compact, low-power and efficient management of wireless audio networks and have implemented their network management apparatus in a semiconductor chip (with software) for a digital audio connectivity application over a radio frequency (RF) link. In this exemplary implementation, and depending on interference conditions, the wireless connectivity provided by this embodiment of the invention, can support up to a 10 meter radio range with a typical range under robust operation and normal interference conditions being 3 meters.

The reader is to understand, however, that the following is just one embodiment of the invention used for a portable audio application and numerous others may be implemented without departing from the inventors' claims herein. For example, the invention may, alternatively, be implemented via other embodiments for many other wireless audio applications including, without limitation, cell phone applications, home stereo speaker applications, automobile audio applications, public address system applications and other known audio applications.

The wireless audio implementation of the invention which is described herein, as an example, also incorporates an ultra-low power 2.4 GHz radio with digital stereo audio interface, integrated ISM band (i.e. the licence-free Industrial, Scientific and Medical frequency band) coexistence functions, and a variety of auxiliary control and communications interfaces and functions. In addition, it incorporates a variety of enhancements which serve to improve the overall audio experience for the user. Such features as acknowledged packet transmission with retransmission, dynamic adjustment of the transmission interval between the audio source and sink, improved audio synchronization, lossless compression, dynamic channel selection and switching, and dynamic adjustment of the transmit power allow the wireless audio system to quickly overcome identified radio interference and transmit a signal whose strength is adjusted according to the surrounding transmission medium.

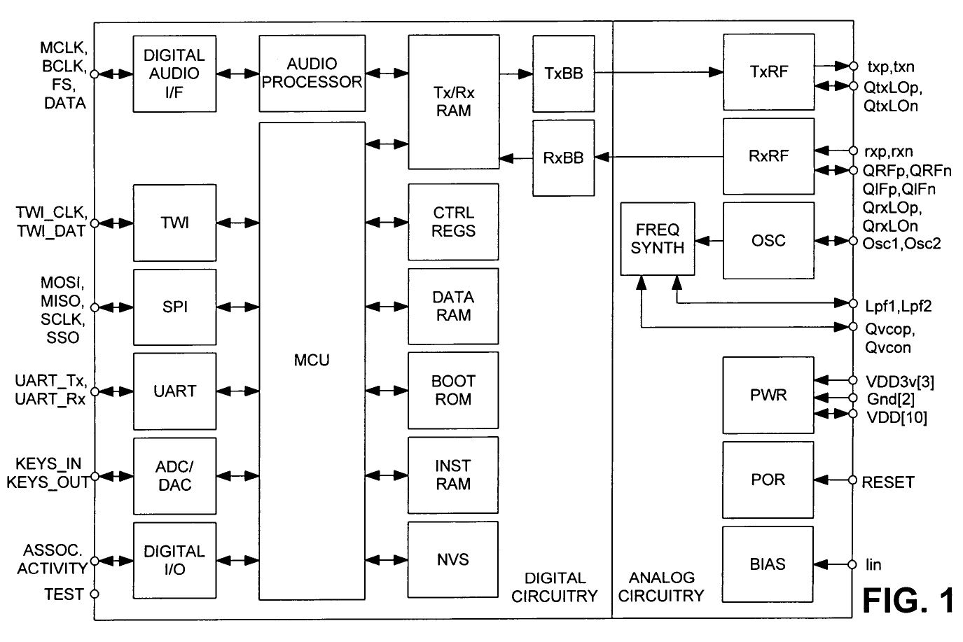

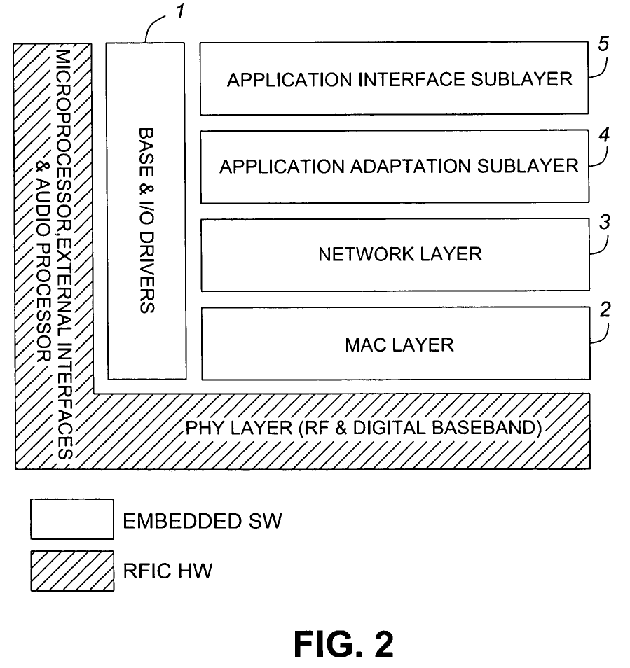

An overview of the overall hardware (circuitry) of an exemplary audio system, in which the management apparatus of the present invention is embodied (not shown by any specific element), is shown by the functional block diagram of FIG. 1 which is presented for the general information of the skilled reader who will be familiar with such items of hardware. An overview of the overall hardware (RFIC HW) and software layers (embedded SW) i.e. functional layers, of the apparatus, which implement the network management functions of the present invention (not shown by any specific element), are shown by FIG. 2 which also is presented for the general information of the skilled reader who will be familiar with these commonly referenced functional layers.

The Base & I/O drivers module 1 forms the foundation upon which the rest of the system software load operates, the functions being performed by this module including startup initialization, task scheduling, interrupt handling, external interface drivers (SPI, TWI, UART), base utilities and audio processor management. The Media Access Control (MAC) layer 2 interfaces with the digital baseband to mediate packet transmission and reception, error detection and packet retransmission, radio duty cycle control, channel scanning and energy detection and channel tuning. The network (NWK) layer 3 incorporates a central state machine that defines the system operational behaviour and the functions of network association, preferred channel sequence (PCS), channel selection and dynamic channel switching 2.4 GHz ISM band coexistence and packet generation and de-multiplexing. The application adaptation sublayer 4 forms the interface between the rest of the system and the application interface sublayer and incorporates the functions of audio data transport, audio control command transport, audio status transport and application-level association and connection management. The application interface sublayer 5 contains the software that interacts with the components and circuitry connected to the wireless audio system and incorporates the functions of startup configuration of subtending components, the audio control and status interface (ACSI) for the system, association trigger and software download control.

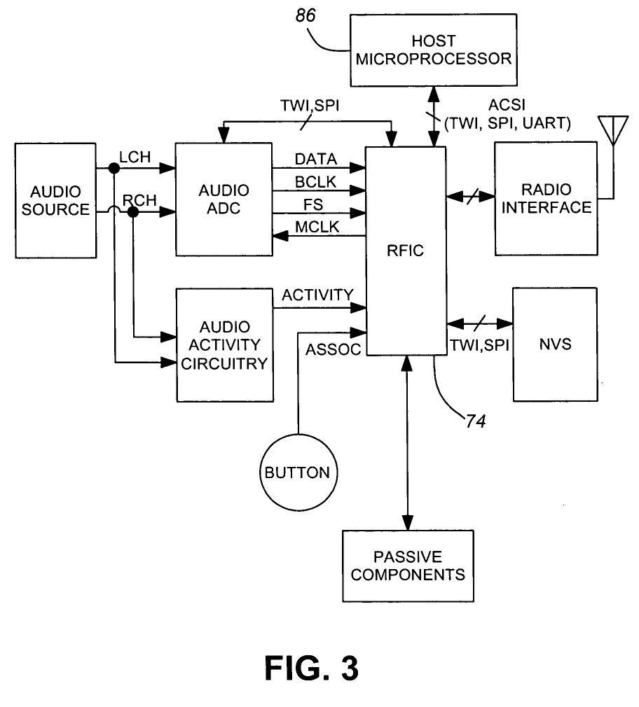

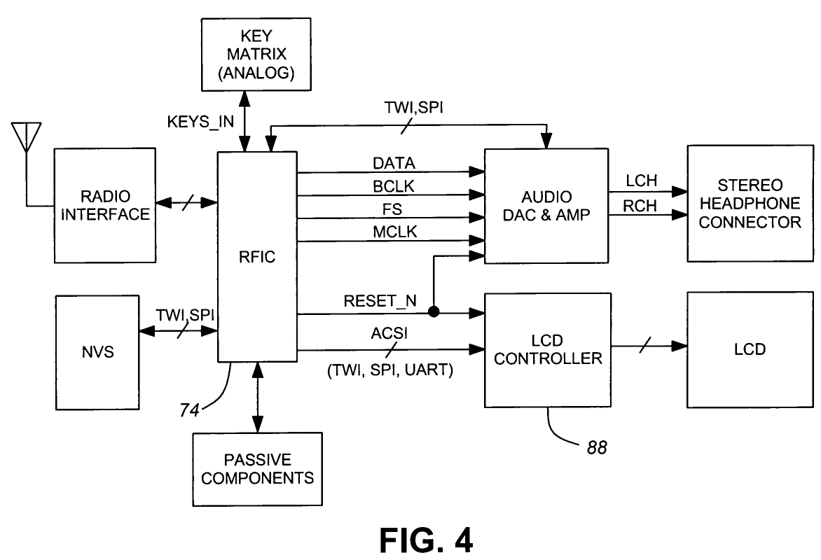

FIG. 3 illustrates, in block diagram format, a portable audio player (as source) application of the system and FIG. 4 illustrates, in block diagram format, a portable audio remote control/headphone (as sink) application of the system (these applications being used to describe an embodiment of the invention claimed herein). It is to be noted, that the invention is not limited to any particular choice of physical implementation of the network management apparatus and, for example, it may be integral to the audio source and associated audio sink devices as depicted by the pictorial illustrations of the drawing figures herein or, alternatively, it could be incorporated into physically separate items which plug-in to, or otherwise connect, to audio source and sink devices.

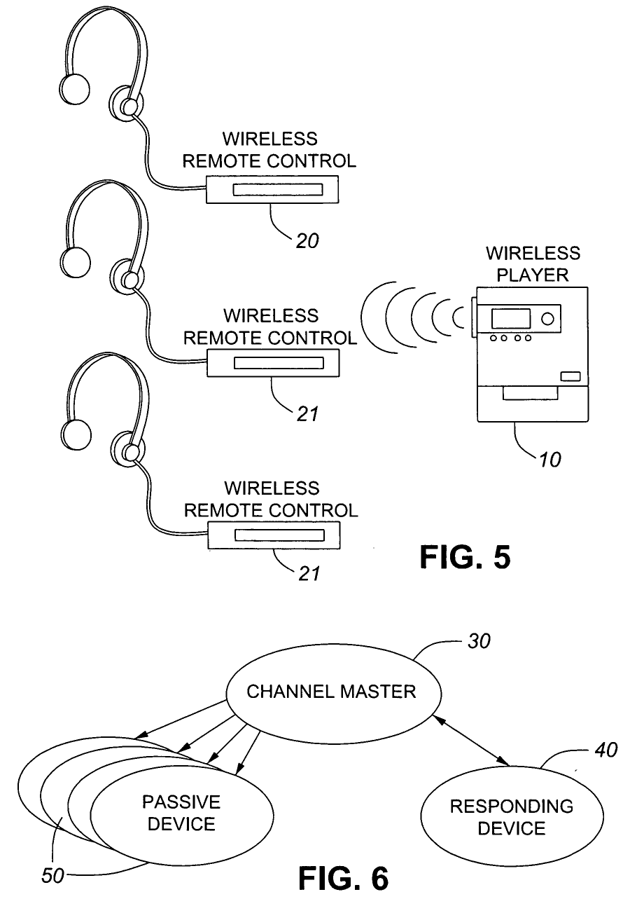

FIG. 5 pictorially illustrates an exemplary wireless audio network in which a wireless audio player 10 (source device) is configured for wireless communication with an associated remote control/headphone 20 (sink device) and also two other, similar sink devices 21 which are passively associated only (i.e. their remote controls cannot respond to the source device 10 when the management system has given that capability to the associated sink device 20). FIG. 6 shows the basic elements of any such wireless audio network, namely, a channel master 30 (being the player 10 in FIG. 5 when so assigned by the management system), a responding device 40 (being the remote control 20 in FIG. 5 when so assigned by the management system) and one or more passive devices 50 (any number of these elements being possible, with these being the devices 21 in FIG. 5). The channel master 30 and responding device 40 are required elements while the passive device 50 is optional. The channel master 30 communicates with one, and only one, receiving device 40 at one time but can communicate to any number of passive devices by multicast. These relationships and limitations are illustrated in FIG. 6 by the one-way and two-way arrows.

All communication is based on a beacon mechanism utilizing a pre-defined data/time interval referred to herein as the “Transport Superframe (TSF)” which is described in the co-pending application filed on 25 February, 2005 and titled “High Quality, Low Power, Wireless Audio System” of the assignee of this application (the Declaration for which was executed on 23 February, 2005), to which reference may be made for background information concerning the foregoing exemplary audio system in which the management apparatus of this invention may be embodied.

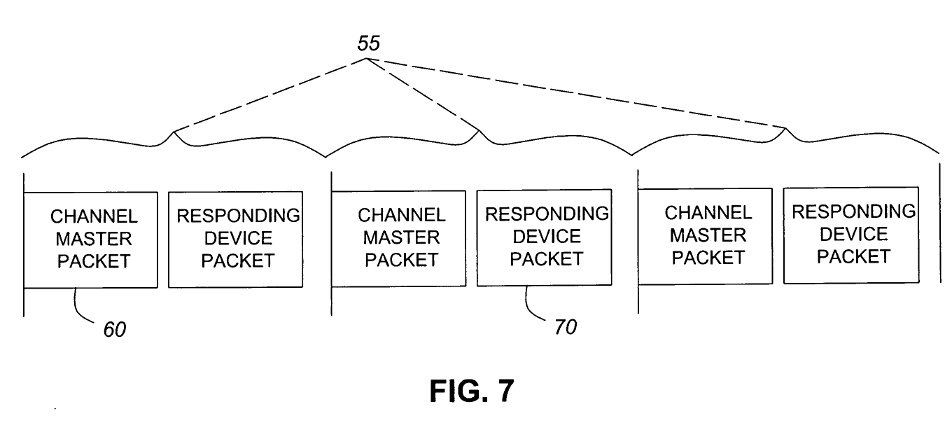

In brief, the channel master 30 defines the wireless channel in use and the timing of the TSF interval (alternatively referred to as the TSF time period or, simply, the TSF period). As shown by FIG. 7, within each TSF interval 55 one message is sent by the channel master 30 i.e. packet 60 and one message is returned by the responding device 40 i.e. packet 70. The channel master 30 always transmits first and defines the TSF interval 55. The responding device 40 always waits to receive first, before it can send its own message within that TSF period 55. Passive devices 50 receive data from the channel master 30, but are not capable of responding. Channel masters 30 and responding devices 40 can both send and receive information. By contrast, passive devices 50 cannot respond to the channel master 30 and, therefore, they can only receive, not send, data.

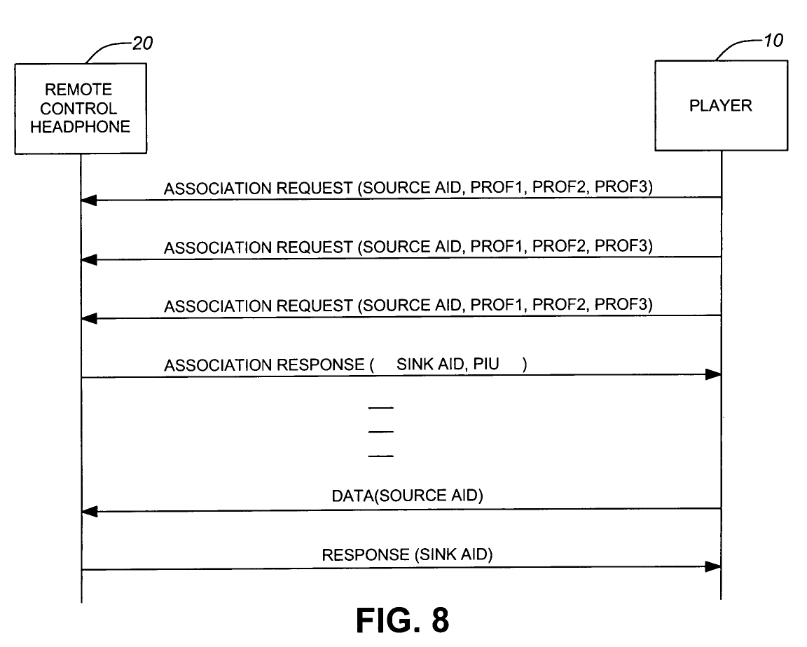

Referring to FIG. 8, the Transport SuperFrame interval is a period of time of defined length that repeats continuously while an audio source 10, playing the role of a channel master, is connected to an audio sink 20, playing the role of the responding device. Within that TSF period of time, there is time allocated for the audio source to access the wireless shared media to send a source packet to the audio sink, and for the audio sink to access the wireless shared media to send a sink packet to the audio source. Since the direction of transmission changes between these two intervals within the TSF, there is time allocated to allow the radios to switch between transmit mode and receive mode and vice-versa. Also, since TSF may contain more time than is required for the transmission of all data, there may also be an idle period allocated where there is no radio transmission. The start of the audio source packet is triggered by the start of the TSF and it is always transmitted, regardless of whether there is audio data in it or not, and of variable length with a defined maximum size. The audio sink device transmits its packet beginning immediately after the end of the audio source packet (after allowing time for the radios to switch direction) and is of variable length with a defined maximum.

For the audio player and remote control/headset application illustrated the packet transmitted by the responding device (here, the sink device) is typically much smaller than the audio source packet but in another application, such as a cell phone application (networking cell phone handset and headset devices), the packets would be about the same size in either direction of communication (and the audio signals would be bidirectional). The audio sink packet, i.e. from the responding device, only sends a packet when it has received a valid packet from the audio source, i.e. from the channel master. A lost or corrupted packet from the channel master is not acknowledged since the responding device has no way of knowing exactly when the end of the channel master's message has occurred and hence when it should begin its own transmission. As described in the aforementioned co-pending application of the assignee of this application (titled “High Quality, Low Power, Wireless Audio System”), certain logic on the channel master handles any such missing acknowledgements.

An audio synchronization function is performed in the audio source and controls the length of the TSF, which information is communicated to the audio sink as overhead in an audio source packet. The length of the TSF takes into account competing system factors; the longer the TSF, the lower the power consumption and the shorter the TSF, the better the resilience to interference.

Because there are many different types of audio source and sink devices for which wireless communications are desired including, as examples, an MP3 player communicating wirelessly with a remote control/headphone set and a home theatre system communicating wirelessly with speakers, it is necessary to establish a common profile and command set (if applicable) between the two devices before any such communications can take place. That is, it must be established, for each device, the applications it supports e.g. an LCD display and the types of devices it may be associated with for such communications. A profile negotiation process is performed to ensure that each device to be associated with another has compatible capabilities and that a suitable profile and command set can be agreed upon and established.

An application profile for a given device is identified by its profile class and its capabilities but it is to be noted that some devices may be capable of supporting more than one profile. For example, a player which is capable of being controlled by a wireless remote control/headphone unit could also interoperate with a simple wireless headphone by disabling its own remote control abilities. Also, a particular wireless device could be of more than one class. For example, such a device might operate as an MP3 player or cell phone based on a user's selection. In such a case, where each class is in common between the application profiles for the wireless devices, a PIU will be established for each class. A few sample application profiles are set out in the Table 1 below.

TABLE 1

| Profile Class | Capabilities | Optional Capabilities |
|---|---|---|
| Portable Audio | Stereo Headphone | |
| | Remote Control | Extended Audio |
| | | Control Commands |
| | LCD Display | |
| Home Stereo | Stereo Audio | |
| Speakers | | |

FIG. 8 illustrates the process of associating two devices (referred to herein as “association”) whereby a first device, being the channel master (the player 10 in this illustration), sends out an Association Request message with its own unique association identification number (the channel master AID, identified in this figure as the “Source AID”) and profile capabilities, i.e. the set of profiles that it can support, being three profiles in this case designated as “Prof1”, “Prof2” and “Prof3”. The other device, being the responding device (the remote control/headphone set 20 in this illustration), then analyzes the list of profiles it received from the player 20 and chooses the most fully featured profile which the two devices have in common, if any. It then returns to the player 20 an Association Response message with its own unique association identification number (the responding device AID, identified in this figure as the “Sink AID”) and an identifier (PIU) which represents its chosen profile i.e. the identified profile becomes the designated Profile In Use (PIU). In addition, if the devices support wireless remote control ability, they also exchange information on extended audio control commands at this time for any optional commands that they support (see the tables towards the end of this description, under the heading “I. Some Sample Control Command Codes”, for a listing of control command codes). Mandatory commands are implicitly supported if a device indicates it supports the generic “remote control” capability, whereby the “capabilities” referred to in Table 1 (and Table 2) identifies mandatory functionality for the referenced class and “optional capabilities” means optional functionality. The PIU dictates which audio-interfaces are enabled and which audio control commands are to be supported, etc.

Table 2 below describes sample application profiles supported by two exemplary devices, namely, an MP3 audio player and a remote control/headphone unit, as well as the resulting PIU and extended command set that is agreed upon following the association procedure. It is to be noted that only those optional commands (listed in Table 2 as Optional Capabilities) that the two devices have in common end up in the Optional Capabilities of the PIU. Further, both devices must support all commands that are listed as being mandatory for a device to claim it supports the Portable Audio/Remote Control profile, e.g., PLAY, STOP, VOL+, VOL−, etc.

TABLE 2

| | | | Remote Control/Headphone | | | | | |
|---|---|---|---|---|---|---|---|---|
| MP3 Player profile | | | profile | | | Profile In Use (PIU) | | |
| Profile | | Optional | Profile | | Optional | Profile | | Optional |
| Class | Capabilities | Capabilities | Class | Capabilities | Capabilities | Class | Capabilities | Capabilities |
| Portable | Stereo | | Portable | Stereo | | Portable | Stereo | |
| Audio | Headphone | | Audio | Headphone | | Audio | Headphone | |
| | Remote | MENU | | Remote | TREBLE+ | | Remote | PAUSE |
| | Control | SELECT | | Control | TREBLE− | | Control | NEXT |
| | | UP | | | BASS+ | | | PREVIOUS |
| | | DOWN | | | BASS− | | | |
| | | EXIT | | | PAUSE | | | |
| | | PAUSE | | | NEXT | | | |
| | | NEXT | | | PREVIOUS | | | |
| | | PREVIOUS | | | | | | |

As indicated, a given device may support more than one profile. Upon start up of the device, an application interface sublayer determines the supported profiles and conveys this information to an application adaptation sublayer as part of the Association Request message. Each profile entry has the following format: class:capabilities:optional capabilities.

For example, using the foregoing examples of a portable audio MP3 player and a remote control/headphone, the profile encodings are determined as set out in Tables 3, 4 and 5 below.

TABLE 3
MP3 Player Profile Encodings

| Profiles | Encoding |
|---|---|
| Portable Audio: Headphone: | 0x00: 01: |
| Portable Audio: Remote/ | 0x00: 03: 20:21:22:23:24:44:46:47 |
| Headphone: Optional capabilities | |

TABLE 4
Remote Control/Headphone Profile Encodings

| Profiles | Encoding |
|---|---|
| Portable Audio: Headphone: | 0x00: 01: |
| Portable Audio: Remote/ | 0x00: 03: 03:04:05:06:44:46:47 |
| Headphone: Optional capabilities | |

TABLE 5
Resulting Profile In Use (PIU)

| Profile | Encoding |
|---|---|
| Portable Audio: Remote/ | 0x00: 03: 44:46:47 |
| Headphone: Optional capabilities | |

A PIU is chosen so that associated devices are given the highest level of common functionality. Since, in the foregoing example both devices support the remote control capability, this is the chosen profile (along with the headphone capability). Similarly, the optional commands that both devices support are chosen i.e., PAUSE, NEXT and PREVIOUS in that example. Once these devices have completed the association procedure, the profile in use (PIU) will have been determined. That is, the PIU was determined to be “0x00:03:44:46:47”. Once this has happened, the devices know which service access point (SAP) primitives need be enabled, and which commands may be allowed to pass through those SAPs.

The active association process is commenced when a unique, user-initiated, event occurs on each of the devices to be associated. These events are referred to as active association triggers. For example, on a mini-disk player the active association trigger may be a Power On Reset (POR) event and on a remote control the active association trigger may be a unique button being pushed.

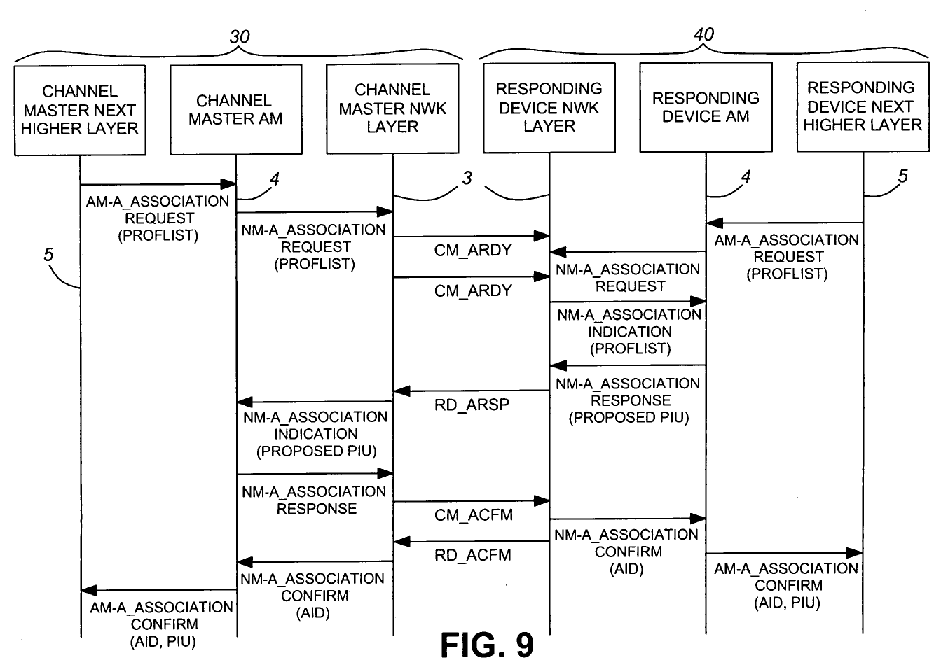

FIG. 9 illustrates sample messages between a channel master 30, e.g. an MP3 player, and a responding device 40 e.g. a remote control/headphone, during active association and profile negotiation between those two devices. At the network layer 3, when in active association mode, the channel master (CM) 30 initiates the exchange by sending out repeated CM_ARdy (active association ready) messages. When/if the responding device (RD) 40 is also put into active association mode, it examines the profiles contained in an CM_ARdy message and deduces a suitable PIU. The responding device then sends back its proposed PIU in an RD_ARsp (active association response) message. The channel master then verifies whether or not the proposed PIU is acceptable. If it is, a CM_ACfm message is sent to the responding device and the responding device confirms this transmission with a RD_ACfm message. At the AM (Application Adaptation Layer, Management SAP) layer 4 on each device, once the PIU is agreed upon between devices and confirmed, a A_ASSOCIATION.confirm is returned to the higher layers 5 containing both the AID of the newly associated device and the agreed upon PIU.

Using the same example as above, the profile (ProfList) sent by the channel master (MP3 player), as referred to in the above message sequence, would be {0x00:01, 0x00:03:20:21:22:23:24:44:46:47}, the ProfList of the responding device (headphone/remote control) would be {0x00:01, 0x00:03:03:04:05:06:44:46:47} and the proposed PIU, determined by the application adaptation layer on the responding device, would be {0x00:03:44:46:47}. Once the association process has been completed, each device saves any and all established PIU's and the AID of each device in non-volatile storage.

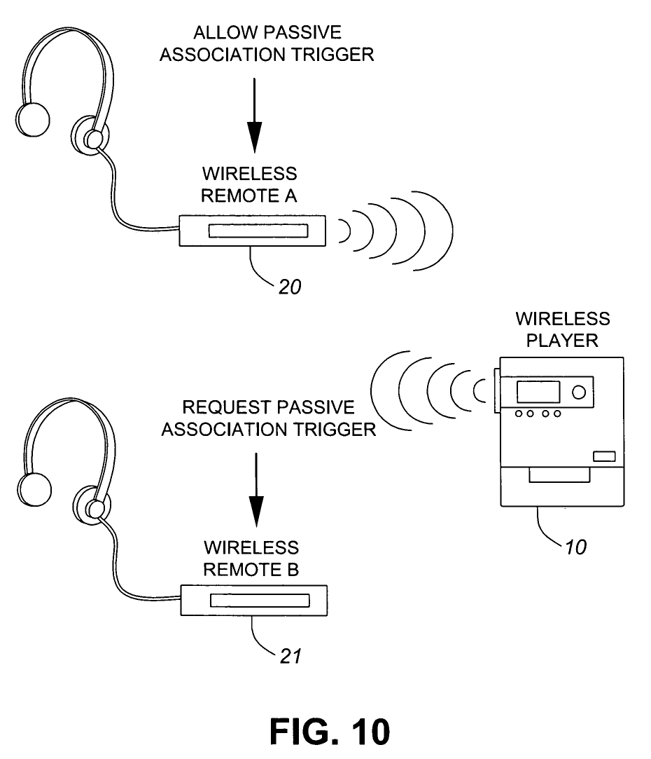

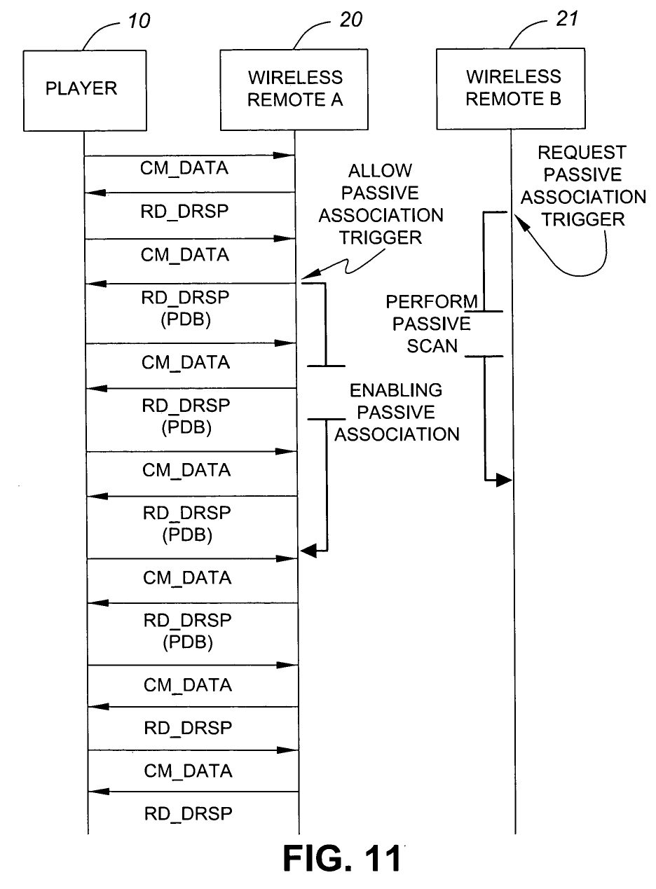

Passive association refers to a mechanism used to allow additional audio sinks to “listen-in” on an existing audio broadcast. This mechanism, illustrated by FIG. 10, is implemented by simultaneously asserting an Allow Passive Association trigger on the already permanently associated wireless remote “A” 20, and a Request Passive Association trigger on another wireless remote “B” 21 seeking to become passively associated. The elegance of this mechanism is that no user action is required to take place on the audio source 10. Advantageously, the behaviour of the audio source 10 is unaltered and, therefore, it can continue to transmit audio data (i.e. play music) without interruption. Instead, the triggering of the passive association protocol allows the associated wireless remote “A” 20 to inform the passive wireless remote “B” 21 of the AID of the audio source 10 and, thereafter, passive wireless remote “B” can receive the transmitted audio data (i.e. listen in on the music) since it has the AID of the desired audio source 10. The message sequence chart of FIG. 11 illustrates the steps of the foregoing passive association process.

When the Allow Passive Association trigger occurs on associated wireless remote “A” 20, it turns on a Passive Device Beacon (PDB) bit in each of the packets it returns to the player 10 (audio source). If, at the same time, the Request Passive Association trigger occurs on wireless remote “B” 21, that wireless remote “B” 21 will scan the available communication channels looking for a message with this bit set. Once it finds such a message, it notes the AID contained in each of the player messages going the other way on this same channel. This will be the AID of the device it is passively associated to. This mechanism allows a virtually unlimited number of additional audio sinks to become associated to a single audio source, i.e. player 10. It is to be noted that the advantageous capability of adding any number of passive sink devices, which stems from the fact that they do not respond to (i.e. acknowledge) the source-transmitted packets, also creates the side effect that these additional audio sinks do not have the same Quality of Service (QoS) as the connection between the channel master 30 and the responding device 40, since the channel master will only retransmit due to lost acknowledgments from its responding device. That is, it is possible that they could experience a degraded signal, relative to the primary connection, but this is unlikely to outweigh the appeal which this broadcast feature commands.

Before the player 10 and remote control 20 can begin to exchange messages, they must both choose a channel, specifically the same channel, on which to communicate. This process is inherently asymmetric; the player 10, which is also the channel master 30, looks for a channel that is not currently being used, while the remote control 20, which is the responding device 40, looks for the channel that is being used by its player. In the context of the embodiment described herein a 16 channel frequency band is used with the center frequency of the first channel being 2403 MHz and the center frequency of the last channel being 2478 MHz.

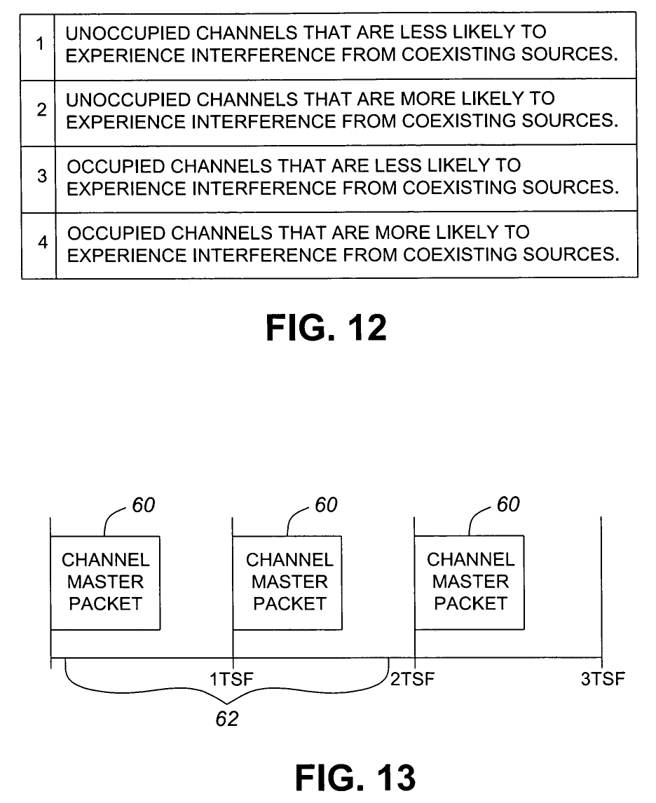

The channel selection process is speeded up by designating a particular channel search sequence, referred to herein as the Preferred Channel Sequence (PCS), that is shared by a set of associated devices. Accordingly, when the associated devices search for a new channel, they will try to first rendez-vous at the first channel in the PCS. If that one is unavailable, then they will both go to the next channel in the PCS, and so on until they find one. The PCS, which is an ordered selection of channels based on preference, is ordered in subgroups (1, 2, 3 and 4 in FIG. 12, for example) according to channel quality, with the channels of each such subgroup being considered to be of like quality to the other channels in the subgroup. The channels in each subgroup may be assigned to that subgroup on the basis, for example, of those channels being deemed less likely to be occupied (subgroups 1 and 2), and either less (subgroup 1) or more (subgroup 2) likely to experience interference with the former appearing earlier in the PCS. Then, the next ordering may be based on those channels deemed more likely to be occupied (subgroups 3 and 4), and either less (subgroup 3) or more (subgroup 4) likely to experience interference with the former appearing earlier in the PCS (but later than those groups less likely to be occupied). In other words, channels that are more likely to experience interference, due to competing protocols such as microwave ovens, will appear later in the PCS than those less likely to experience interference. Within each subgroup, the channels are also randomized, i.e. seeded using some function such as modulo of the device's AID, so that players located in the same vicinity are less likely lock onto to the same PCS subgroup listing.

The audio source 10 derives its initial PCS when it first powers up. At that time it does a complete energy scan of the applicable band (in the context of the exemplary embodiment, being 2.4 GHz) and identifies any channels that are occupied. It then constructs a PCS priority list according to that set out in FIG. 12. Once an audio source/channel master 30 has derived a PCS and immediately after establishing communications, it communicates this list to its responding device 40 and any passively associated sink devices, referred to as passive devices 50 in FIG. 6. From then on, whenever a channel master 30, whether it's the audio source 10 or not (see following paragraph), re-establishes communications following a Standby/Sleep period, or following Dynamic Channel Selection (DCS), it will first refresh its image of the PCS and then send this revised list to the other devices of the audio network. The latter not only ensures that the PCS accurately reflects the current band state, but it also handles the case where the responding device has cycled power and lost the previous PCS info, since the last time they were connected. In addition, whenever the audio source regains channel master-ship, i.e. following a channel master switch between itself and the responding device, it will rebroadcast its current picture of the PCS to, once again, attempt to keep the passive devices in synch.

It is to be noted that the wireless devices of a given network embodying the present invention could be configured to act as both an audio source and sink; for example, in a cell phone application, each of the handset and headset devices may function as both audio source and audio sink, and one such device will be the channel master (always) and the other the responding device (always).

Upon power up, the channel master 30, being the player 10 in this example, scans for available channels, using energy detection to do so. It uses the PCS described above, claiming the first available channel (i.e. the idle channel for which energy above a threshold is not detected) by immediately sending out, at regular intervals, beacons containing its AID. The responding device 40, being the remote control device 20 in this example, uses the same PCS as the player 10, and listens for those beacons (thus, the responding device looks for channels with energy). Once it finds the beacon from its player it knows that it is ready to begin receiving audio data from that player and, in the case of wireless remote control devices, sending the player audio commands, such as Play.

FIG. 13 illustrates a maximum scan period 62 for finding the channel master 30. Specifically, a sink device searching for a channel which is occupied by another particular device, need only scan for a maximum period of slightly less than two times the TSF size (i.e. 2×TSF) in order to reliably locate that particular device. A lesser amount of time may succeed in finding the channel master, i.e. it could take less an one TSF, but once it has waited for about two TSF's and still has not detected the channel master, it can rule out the channel. It searches for a particular AID in messages from the channel master. Upon the next restart, the channel selection process is performed anew.

The channel selection process relies on the fact that all connected messaging uses, for the message interval, the Transport Superframe (TSF). On top of this, the receiving device will look for a message containing the association ID (AID) of its channel master. This allows a device to very quickly scan prospective channels and reject them if they are not suitable. The ability to very quickly scan channels and rendez-vous is very important for low power wireless applications such as portable wireless audio.

In managing a wireless audio network it is important to also control the effect one device has on other wireless devices in the network. For example, a user will not be pleased if his/her audio device knocks out his/her wireless laptop every time the control command “Play” is pressed. To address this, the responding device periodically hops to the first alternate channel in the PCS and performs a brief passive scan. The frequency of this hop-and-scan pre-emptive scanning process is determined either on the basis of the amount of spare time available, such as every TSF if time permits and provided that channel tuning is fast enough, or by sacrificing a TSF every so often. For both, the intent of these pre-emptive scans is to build up a more accurate picture of the idle state of the next alternate channel in the PCS, without abandoning the current channel (since the channel master does not participate in this hop-and-scan) and without interrupting audio data flow (since the responding device will finish its scan and return to connect with the channel master before the audio buffer has been expended). It is to be understood that this mechanism will work best if channel tune times are quite fast (e.g. less than 1 ms). If, at any time, the pre-emptive scanning detects any activity, the channel in question is removed from the head of the PCS list and re-sorted to be appropriately lower in the list. The procedure is then restarted on the new first alternate channel.

A possible alternative to the foregoing process is to examine the first channel at a given frequency and the second alternate channel at a reduced frequency, intermixed with the foregoing method. This would also allow the manager to build up a picture (even though a less accurate one) of the second alternate channel.

In the channel selection process, to find a free channel, the channel master and responding and passive sink devices perform the following generic procedures for each channel in the PCS:

The channel master:

Channel Tune to new frequency;

perform Untimed Receive for up to 1 nominal TSF Period;

If (energy>threshold)//this channel is not ideal
Record energy level for later use;
Continue to next channel in sequence;

Else//idle channel detected
Start sending out message with my AID; 11 Success

The channel master also updates the PCS, if required, and sends out a copy upon reconnection. If the device has not found an idle channel once it has examined all of the channels in the PCS, it may decide to lower its standards and take the channel that exhibited the least energy. That is, at first it will look for a completely idle channel with no energy detected but, if it cannot find such a channel, it may resort to using a channel with a low level of noise (i.e. energy) in it (i.e. low enough to be usable still). Then, each time the channel master goes through the PCS, it will look for a certain threshold level considered to be “good enough” and the channel master's threshold (i.e. its concept of what “idle” is) will change as conditions dictate.

The responding device and passive audio sinks (to find the channel occupied by their channel master):

Channel Tune to new frequency;

perform Untimed Receive for up to 2*Long TSF Period;

If (no packet received OR packet not from my Channel Master)
Continue to next channel in sequence;

Else//Success
If (I'm a Responding Device)
   Respond;

If channel interference is prolonged and the level in an interference buffer has dropped to pre-defined threshold, the devices will switch to a new channel, using the PCS as a reference. The audio devices use Dynamic Channel Selection (DCS) to avoid interruptions in the audio flow due to a deteriorating channel because of active interference. DCS refers to channel selection that occurs after the audio flow has already been established.

To dynamically select another channel, the devices must first verify that a new channel is free for use. To do so, a device must first tune its receiver to a new channel frequency (channel tune time (TUNE)), and then scan, using energy detection, for up to a single long TSF period (SCAN) to ascertain whether this channel is being occupied by another device. This dynamic selection method requires that the devices first make a decision to abandon their channel before they begin their search for a new channel. To avoid abandoning their channel prematurely (e.g. if the interference is temporary) all devices delay their search for a new channel for a period of time, defined as the Chip Hold-off (CHO). Also, so as to minimize the chances of two networks first interfering with one another, and then both abandoning the channel at the same time, an additional hold off, designated the Network Hold Off (NHO), is defined. The NHO for each network is randomized at runtime and chosen to be some integer multiple of the TSF period.

Once the CHO and the NHO have been observed, the channel master leads the search by first leaving the current channel. It then tunes and scans successive channels, searching for a free one. As soon as a channel is found to be idle, the channel master claims this idle channel by automatically sending out its data beacon. The audio sink(s) delay their search for the channel to ensure that the channel master finds it first and claim the channel for them. This additional hold off is designated the Sink Hold Off (SHO).

It is to be noted that in this dynamic channel selection the two (or more) participating devices decide to switch channels in a predetermined manner and without requiring an exchange of control messages beforehand. This is critical in environments of extreme interference which renders communication impossible in the current channel (jamming). In order for the hold-offs on the devices to commence countdown at the same time, the two devices must deduce at the same time that the DCS is required. This is achieved by having both devices trigger their DCS algorithms off of a certain ACK deficit. For example, both devices will trigger their hold-off timers after missing 10 out of the last 12 possible acknowledgements. It is to be noted that each device acknowledges reception from its mate by including a Data Sequence Number (DSN) in its packet header. Also, the tuned hold-offs ensure that the dynamic channel selection process completes as quickly as possible and this is important in order to ensure that the channel switching takes place quickly and does not impact the audio stream.

The network management apparatus of the present invention further provides improved interoperability of different wireless devices by means of normalizing control and status interfaces which communicate normalized audio control command and status information between the devices, and establish interoperability between even those devices which are configured for communicating incompatible data streams (prior to normalization).

Two types of physical interfaces are provided for the communication of audio control commands and audio status information between wireless audio devices as follows: (i) an analog key voltage interface (AKEY) which is used for communicating control command information to/from the wireless device; and, (ii) a digital serial messaging interface, the Audio Control & Status Interface (ACSI), which is used for both control command or status information communication. Table 5 below sets out the usages for these two interfaces (and it is to be noted that these interfaces are not required if no remote control or display functions are included in the application, i.e. if the application includes audio only).

TABLE 5

| | The Analog | The Audio |
|---|---|---|
| | Key Voltage | Control & Status |
| | Interface (AKEY) | Interface (ACSI) |
| Control Commands | ✓ | ✓ |
| Status Information | | ✓ |

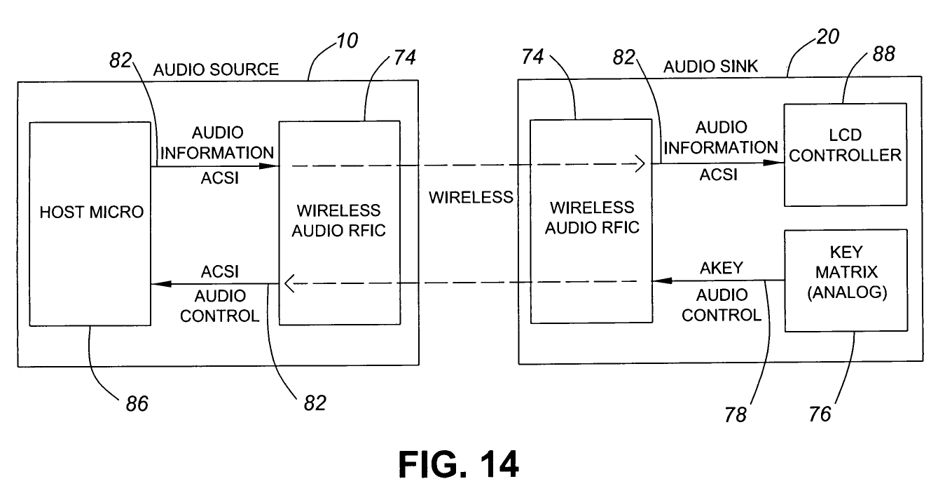

As illustrated by FIG. 14, these interfaces are implemented at the physical pin interface of a wireless audio RFIC 74 (Radio Frequency Integrated Circuit). The AKEY interface 78 is used by the RFIC 74 in the sink device to translate the analog input from an analog KEY Matrix 76. The ACSI interface 82 is used in the source device 10 between the wireless RFIC 74 and a local microprocessor 86 to communicate audio control and status information to/from the RFIC (and in the sink device 20 between the RFIC 74 and LCD controller 88). These configurations, which enable interoperability, are shown in FIG. 14 and described more fully below.

For the Analog Key Voltage Interface (AKEY) 78 the RFIC 74 is configured to identify whether the application is using analog voltages to represent audio playback control commands (e.g. Play, Stop, FF, . . . ). If so, the configuration information provides a mapping between the commands and the analog voltage levels representing them, a sample AKEY mapping table, for a remote control device, is set out in Table 6 below.

TABLE 6

| Control Command | Voltage |
|---|---|
| PLAY | 0.326 +/− 20 mV |
| STOP | 0.623 +/− 20 mV |
| FF | 0.813 +/− 20 mV |
| REWIND | 0.993 +/− 20 mV |
| VOL+ | 1.194 +/− 20 mV |
| VOL− | 1.375 +/− 20 mV |
| ASSOCIATION | 1.756 +/− 20 mV |

For an audio sink application 20 (e.g. remote control device), the audio playback control buttons result in a signal of these voltage levels appearing on the RFIC 74 pin that connects to an internal low frequency Analog-to-Digital Converter (ADC) (not shown). This ADC is configured to sample this signal on a fixed interval basis, for example, every 10 ms. The RFIC software maps these voltage levels to the corresponding playback control commands that are sent to the audio source. In the audio source 10, at its RFIC 74, the received control commands (voltage levels) could, likewise, be converted through a low frequency Digital-to-Analog Converter (DAC) to the same voltage levels (but such a configuration is not shown by FIG. 14).

As will be understood by the reader, the Analog Key Voltage Interface (AKEY) specifies a discrete set of analog voltage levels that are assigned individual command meanings by the application, for example the command “PLAY” could be assigned a voltage level of 0.1V. Importantly, each application module may have its own unique mapping of commands to voltages and, for the described exemplary embodiment, a supported voltage range for commands of 0.1V through 2.0V was selected. Of course, even though these individual voltage settings are application dependant it is necessary that the circuitry ensure that an accurate voltage is supplied for each command to be recognized, for example, an accuracy level of +/−20 mV. When no commands are being asserted (ON) the voltage will rest at a level above 2.0V.

The Audio Control and Status Interface (ACSI) 82 is a serial, bidirectional protocol and a standard message set to support communication between a wireless RFIC 74 and an external microcontroller. As aforesaid, the external microcontroller may be a portable audio player controller 86 or a sink device LCD controller 88 or other controller. The protocol is run over a common-type serial interface i.e. a UART (Universal Asynchronous Receiver-Transmitter), SPI (Serial Peripheral Interface) or TWI (Two-Wire Interface) according to whatever such interface is available. The interface supports communication of the following types of audio information:
Audio playback control commands (e.g. Play, Stop, Rewind, FastForward, etc.).
Audio playback status information (e.g. Playing, Stopped, Paused, EQ Mode, etc.).
Audio playback song information (e.g. Song Title, Artist, Playtime, etc.).

It also allows the system to communicate certain wireless management metrics, namely:
Received Signal Strength Indication (RSSI).
Association Indication.
Connection Indication.

The ACSI interface can operate on any of the wireless RFIC communications ports including SPI, TWI and UART. The assignment to a port is determined by startup configuration information.

Due to the close proximity of the RFIC 74 with the remainder of the associated network circuitry at the wireless device, LVTTL (Low Voltage TTL), noise immunity and inherent synchronization of the standard serial interfaces, the ACSI interface is expected to be free of transmission errors. Therefore, no parity check fields are appended to the messages and the RFIC 74 does not expect confirmation of data packet receipt at the interface. The packets can be sent at any time and require no acknowledgement.

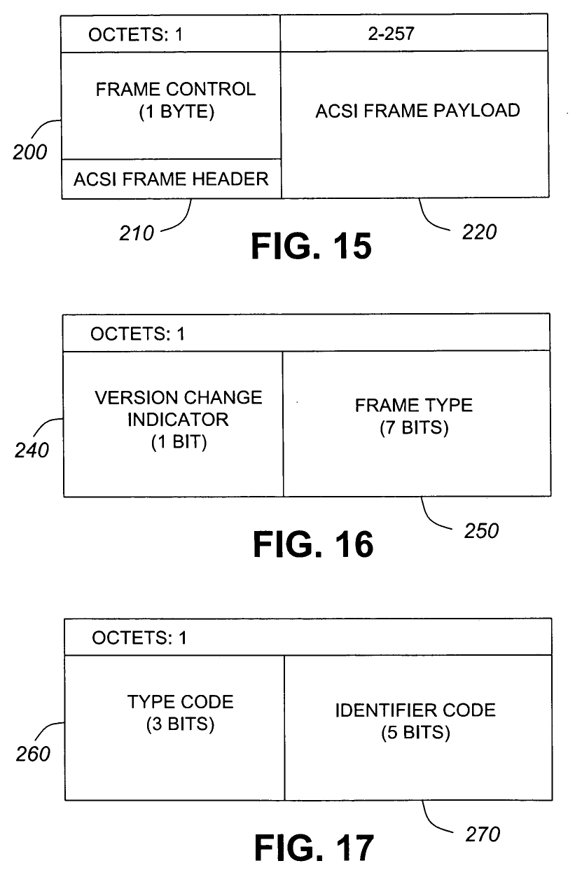

The generic ACSI frame structure is shown by FIG. 15, with each frame comprising up to 258 octets (including header 210 and payload 220). Each control frame, and each status frame, contains a Frame Control byte 200. This byte is made up of a Version Change Indicator 240 and a Frame Type field 250, as illustrated by FIG. 16. The Version Change Indicator bit 240 represents (identifies) the ACSI messaging protocol version e.g. a value of ‘0’ may be used to indicate that the protocol and frame formats described herein are in use and a value of ‘1’ may be used to indicate that a modified version of this protocol is in use. This allows the system to handle a situation in which two devices use different versions.

The Frame Type field 250 is used to indicate the type of frame being processed (i.e. a control or status type frame) as follows under Table 7:

TABLE 7

| Frame Type | Identifier | Frame Length (octets) |
|---|---|---|
| ACSI Control Frame | 0x0 | 3 |
| ACSI Status Frame | 0x1 | 4-258 |

An ACSI Control Frame carries audio control command information, e.g., Play, Stop, etc. An ACSI Status Frame carries audio status information, e.g., Artist, Title, etc.

Each control frame or status frame contains a type-identifier field which uniquely identifies the control command or status information within the frame. FIG. 17 shows the format of the generic type-identifier. In the case of each kind of ACSI information, control or status, the type-identifiers are constructed by creating this single byte entity which contains the type code 260 in the high-order three bits and the identifier code 270 in the low-order five bits. Together, they form a unique type-identifier code.

The following are some sample type-identifiers for selected control commands and status information:

| | Type-Identifier |
|---|---|
| Control Commands | |
| “VOL+”, a signal control command | ‘0x01’ |
| “REW”, a recorded audio control command | ‘0x43’ |
| “MUTE”, a live audio control command | ‘0x76’ |
| Status Information | |
| “TRACK”, an audio track status | ‘0x21’ |
| “BALANCE”, an audio status | ‘0x46’ |
| “CONNECTION INDICATION”, a wireless status | ‘0x64’ |

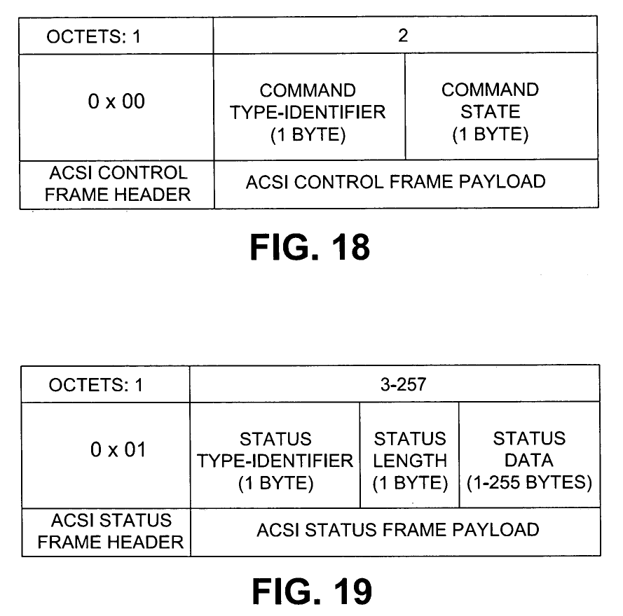

ACSI control frames always contain two bytes of payload, a one byte command type-identifier field, and a one byte command state field. Refer to the Control Code and Status Code Tables below for the complete list of supported command type-identifier values. The command state can either be ‘0’ for ‘OFF’, or ‘1’ for ‘ON’. FIG. 18 illustrates the ACSI control frame format.

As illustrated by FIG. 19, ACSI status frames contain from 3 to 257 bytes of payload, depending on the type of status information. The frame payload contains a one byte status type-identifier field, a one byte status length field, and a 1 to 255 byte status data field. Refer to the Control Code and Status Code Tables below for the complete list of supported audio status and wireless device status type-identifier values.

In the Tables below, exemplary type-identifiers for control commands (I) and status information (II) are listed, as well as exemplary profile class codes (III) and profile capability codes (IV).

1. Some Sample Control Command Codes

TABLE 8
ACSI Control Command Type Codes

| Command Type | Type Code | Description |
|---|---|---|
| Signal Control | 0x0 | Commands used to control audio |
| | | signal amplitude or quality. |
| Display Navigation | 0x1 | Commands used to control a |
| | | display and to navigate a menu. |
| Recorded Audio | 0x2 | Commands used to create and |
| | | play back audio recordings. |
| Live Audio | 0x3 | Commands used to control live |
| | | audio feeds. |
| Wireless | 0x4 | Commands used to manage the |
| Management | | wireless link. |

TABLE 9
Control Commands for Signal Control

| | | | Mandatory |
|---|---|---|---|
| | | | (M) or |
| | Identifier | | Optional |
| Command | Code | Command Semantics | (O) |
| VOL− | 0x00 | To decrease the audio signal | M |
| | | by an increment. Note - some | |
| | | devices will distinguish how | |
| | | long the command remains | |
| | | asserted (ON). Continual | |
| | | assertion may cause the | |
| | | volume to decrease by | |
| | | several increments. | |
| VOL+ | 0x01 | To increase the audio signal | M |
| | | by an increment. Note - some | |
| | | devices will distinguish how | |
| | | long the command remains | |
| | | asserted (ON). Continual | |
| | | assertion may cause the | |
| | | volume to increase by | |
| | | several increments. | |
| EQ MODE | 0x02 | Equalizer Mode - allows the | O |
| | | user to cycle through a | |
| | | selection of music types, | |
| | | e.g., Rock, Classical, Pop, | |
| | | etc., in order to automa- | |
| | | tically adjust the equalizer | |
| | | settings to suite the music | |
| | | type. | |
| TREBLE− | 0x03 | To decrease the treble level | O |
| | | I by an increment. Note - | |
| | | some devices will distinguish | |
| | | how long the command remains | |
| | | asserted (ON). Continual | |
| | | assertion may cause the | |
| | | treble to decrease by | |
| | | several increments. | |
| TREBLE+ | 0x04 | To increase the treble level | O |
| | | I by an increment. Note - | |
| | | some devices will distinguish | |
| | | how long the command remains | |
| | | asserted (ON). Continual | |
| | | assertion may cause the | |
| | | treble to increase by | |
| | | several increments. | |
| BASS− | 0x05 | To decrease the bass level | O |
| | | I by an increment. Note - | |
| | | some devices will distinguish | |
| | | how long the command remains | |
| | | asserted (ON). Continual | |
| | | assertion may cause the | |
| | | bass to decrease by several | |
| | | increments. | |
| BASS+ | 0x06 | To increase the bass level | O |
| | | I by an increment. Note - | |
| | | some devices will distinguish | |
| | | how long the command remains | |
| | | asserted (ON). Continual | |
| | | assertion may cause the | |
| | | bass to increase by several | |
| | | increments. | |
| BALANCE− | 0x07 | To move the stereo balance | O |
| | | from the right audio channel | |
| | | to the left audio channel | |
| | | by an increment. Note - | |
| | | some devices will distinguish | |
| | | how long the command remains | |
| | | asserted (ON). Continual | |
| | | assertion may cause the | |
| | | balance to move by several | |
| | | increments. | |
| BALANCE+ | 0x8 | To move the stereo balance | O |
| | | from the left audio channel | |
| | | to the right audio channel | |
| | | by an increment. Note - | |
| | | some devices will distinguish | |
| | | how long the command remains | |
| | | asserted (ON). Continual | |
| | | assertion may cause the | |
| | | balance to move by several | |
| | | increments. | |

TABLE 10
Control Commands for Display Navigation

| | | | Mandatory |
|---|---|---|---|
| | Identi- | | (M) or |
| | fier | | Optional |
| Command | Code | Command Semantics | (O) |
| MENU | 0x00 | To enter Menu mode. Menus are | O |
| | | arranged in a simple top-down | |
| | | hierarchy | |
| SELECT | 0x01 | To enter or activate the | O |
| | | indicated menu option | |
| UP | 0x02 | To move to the next menu option | O |
| DOWN | 0x03 | To move to the previous menu | O |
| | | option | |
| EXIT | 0x04 | To exit or stop the indicated | O |
| | | or activated menu option | |

TABLE 11
Control Commands for Recorded Audio

| | | | Mandatory |
|---|---|---|---|
| | Identi- | | (M) or |
| | fier | | Optional |
| Command | Code | Command Semantics | (O) |
| PLAY | 0x00 | To cause a device to emit | M |
| | | recorded audio | |
| STOP | 0x01 | To cause a device to stop | M |
| | | emitting recorded audio, | |
| | | or to stop recording audio. | |
| | | The position of the PLAY/ | |
| | | RECORD head is dependent | |
| | | on the media being used. | |
| | | For magnetic tapes, the | |
| | | position will not change. | |
| | | For digital disks and | |
| | | hard drives, the position | |
| | | will revert to the | |
| | | beginning of the media. | |
| FF | 0x02 | To rapidly step through | M |
| | | the current audio track in | |
| | | the forward direction. Or | |
| | | onto to the next audio | |
| | | track. Note - some devices | |
| | | will distinguish how long | |
| | | the command remains asserted | |
| | | (ON). Continual assertion | |
| | | may cause the rate of | |
| | | stepping to increase. | |
| REW | 0x03 | To rapidly step through | M |
| | | the current audio track in | |
| | | the reverse direction. Or | |
| | | onto to the previous audio | |
| | | track. Note - some devices | |
| | | will distinguish how long | |
| | | the command remains asserted | |
| | | (ON). Continual assertion | |
| | | may cause the rate of | |
| | | stepping to increase. | |
| PAUSE | 0x04 | To temporarily stop the | O |
| | | playback of recorded | |
| | | audio, without altering | |
| | | the position within the | |
| | | track. | |
| REC | 0x05 | To begin recording audio | O |
| NEXT | 0x06 | To step to the next audio | O |
| | | track | |
| PREVIOUS | 0x07 | To step to the previous | O |
| | | audio track | |
| RANDOM | 0x08 | To randomly play audio | O |
| | | tracks, i.e., they will not | |
| | | be played in sequential | |
| | | order | |

TABLE 12
Control Commands for Live Audio

| | | | Mandatory |
|---|---|---|---|
| | Identi- | | (M) or |
| | fier | | Optional |
| Command | Code | Command Semantics | (O) |
| CONNECT/ | 0x00 | To establish an audio | M |
| CALL/SEND | | connection to a live | |
| | | audio source. To Call | |
| | | the given phone number. | |
| DISCONNECT/ | 0x01 | To discontinue an | M |
| END | | existing connection to | |
| | | a live audio source. | |
| | | To end the current | |
| | | call. | |
| REJECT | 0x02 | To reject the attempted | O |
| | | connection/call. | |
| REDIAL | 0x03 | To reconnect/redial | O |
| | | the last attempted | |
| | | connection. | |
| HOLD | 0x04 | To place the current | O |
| | | connection/call in | |
| | | the background. | |
| | | Connection has not | |
| | | been terminated but | |
| | | the audio has been | |
| | | muted and the user | |
| | | is able to make | |
| | | another connection. | |
| ANSWER | 0x05 | To accept the attempted | O |
| | | connection/call. | |
| MUTE | 0x06 | To prevent the received | O |
| | | audio, from a live audio | |
| | | connection, from reaching | |
| | | the earphones, speakers, | |
| | | or recording device. | |

TABLE 13
Control Commands for Wireless Management

| | | | Mandatory |
|---|---|---|---|
| | Identi- | | (M) or |
| | fier | | Optional |
| Command | Code | Command Semantics | (O) |
| ASSOCIATION | 0x00 | To trigger an association | O |
| | | using a dedicated button | |
| | | on the audio device, e.g., | |
| | | Player or Remote Control. | |

II. Status Codes

TABLE 14
ACSI Status Types

| | Type | |
|---|---|---|
| Information Type | Code | Description |
| Display Control | 0x0 | Display control commands. |
| Audio Track Info | 0x1 | Information about the audio track being |
| | | played. |
| Audio Status Info | 0x2 | State information about the audio |
| | | source and the audio signal being sent. |
| Wireless Status | 0x3 | State information about the wireless |
| Info | | connection or the local wireless device. |

TABLE 15
Display Control

| | | | | Mandatory |
|---|---|---|---|---|
| | Identi- | | | (M) or |
| | fier | Data | | Optional |
| Field | Code | Type | Description | (O) |
| BEGIN | 0x00 | n/a | Signals the beginning | O |
| UPDATE | | | of a series of update | |
| | | | messages. If these are | |
| | | | used to update a display | |
| | | | the device should wait | |
| | | | for the END UPDATE signal | |
| | | | before refreshing the | |
| | | | screen. | |
| END | 0x01 | n/a | Signals that the last | O |
| UPDATE | | | update message has | |
| | | | been received and that | |
| | | | the display may now | |
| | | | be refreshed. | |

TABLE 16
Audio Track Information

| | | | | Mandatory |
|---|---|---|---|---|
| | Identi- | | | (M) or |
| | fier | Data | | Optional |
| Field | Code | Type | Description | (O) |
| TITLE | 0x00 | NULL- | The title of the | M |
| | | terminated | current recorded | |
| | | ASCII string | audio track or of | |
| | | (up to 64 | the live audio | |
| | | bytes) | presentation. | |
| TRACK | 0x01 | 1-byte | The track number | M |
| | | unsigned | of the current | |
| | | integer | recorded audio | |
| | | | piece. | |
| ELAPSED | 0x02 | NULL- | The elapsed time | M |
| TIME | | terminated | of the current | |
| | | ASCII string | recorded audio | |
| | | (up to 64 | track or of the | |
| | | bytes) | live audio | |
| | | | presentation. | |
| ARTIST | 0x03 | NULL- | The artist that | O |
| | | terminated | performed the | |
| | | ASCII string | recorded audio | |
| | | (up to 64 | piece. | |
| | | bytes) | | |
| ALBUM | 0x04 | NULL- | The album or com- | O |
| | | terminated | pilation that | |
| | | ASCII string | contains the | |
| | | (up to 64 | current set of | |
| | | bytes) | recorded audio. | |
| YEAR | 0x05 | 4-byte ASCII | The year that the | O |
| | | | album was recorded. | |
| GENRE | 0x06 | NULL- | The genre of the | O |
| | | terminated | recorded music. | |
| | | ASCII string (up | | |
| | | to 64 bytes) | | |

TABLE 17
Audio Status Information

| | | | | Mandatory |
|---|---|---|---|---|
| | Identi- | | | (M) or |
| | fier | Data | | Optional |
| Field | Code | Type | Description | (O) |
| VOLUME | 0x00 | 1-byte | The volume level | O |
| LEVEL | | unsigned | of the audio signal. | |
| | | integer | | |
| TREBLE | 0x01 | 1-byte | The treble setting | O |
| LEVEL | | unsigned | of the audio signal. | |
| | | integer | 128 being nominal | |
| | | | treble. 1 being | |
| | | | minimum treble, | |
| | | | 255 being maximum | |
| | | | treble. | |
| BASS | 0x02 | 1-byte | The bass setting of | O |
| LEVEL | | unsigned | the audio signal. | |
| | | integer | 128 being nominal | |
| | | | bass. 1 being | |
| | | | minimum bass, | |
| | | | 255 being maximum | |
| | | | bass. | |
| BALANCE | 0x03 | 1-byte | The balance between | O |
| | | unsigned | the right and left | |
| | | integer | audio channels. | |
| | | | 128 being exactly | |
| | | | balanced. 1 being | |
| | | | full left channel, | |
| | | | 255 being full | |
| | | | right channel. | |
| PLAYING | 0x04 | n/a | The device is | O |
| | | | currently playing | |
| | | | recorded audio. | |
| STOPPED | 0x05 | n/a | The device is | O |
| | | | currently stopped. | |
| PAUSED | 0x06 | n/a | The device is | O |
| | | | currently paused. | |
| REWINDING | 0x07 | n/a | The device is | O |
| | | | currently re- | |
| | | | winding the | |
| | | | recorded audio. | |
| FAST | 0x08 | n/a | The device is | O |
| FOR- | | | currently fast | |
| WARDING | | | forwarding the | |
| | | | recorded audio. | |
| EQ MODE | 0x09 | n/a | The device is | O |
| | | | currently is in | |
| | | | equalizer mode, | |
| | | | e.g., Rock, Pop, | |
| | | | Jazz, Classical, | |
| | | | etc. | |

TABLE 18
Wireless Status Information

| | | | | Mandatory |
|---|---|---|---|---|
| | Identi- | | | (M) or |
| | fier | Data | | Optional |
| Field | Code | Type | Description | (O) |
| RECEIVED | 0x00 | 1-byte | The received signal | O |
| SIGNAL | | unsigned | strength indication. | |
| STRENGTH | | integer | | |
| INDICATION | | | | |
| ATTEMPTED | 0x02 | n/a | An association is | O |
| ASSOCIATION | | | being attempted by | |
| INDICATION | | | the remote device. | |
| ASSOCIATION | 0x03 | n/a | An association has | O |
| COMPLETE | | | completed between | |
| INDICATION | | | the local device | |
| | | | and a remote | |
| | | | device. | |
| CONNECTION | 0x04 | n/a | A connection has | O |
| INDICATION | | | been established. | |
| DIS- | 0x05 | n/a | A connection has | O |
| CONNECTION | | | been broken. | |
| INDICATION | | | | |

III. Profile Class Codes

TABLE 19
Profile Class Codes

| | Identi- | |
|---|---|---|
| Class | fier | Description |
| PORTABLE | 0x00 | This class encompasses all audio |
| AUDIO | | applications where one or more of the |
| | | wireless endpoints are portable. |
| HOME | 0x01 | This class encompasses all audio |
| THEATRE | | applications in the home |
| | | theatre/audio environment. |
| AUTOMOBILE | 0x02 | This class encompasses all audio |
| AUDIO | | applications in the car audio |
| | | environment. |
| CELLPHONE | 0x03 | This class encompasses all audio |
| | | applications in the cellphone |
| | | environment. |
| GAMING | 0x04 | This class encompasses all audio |
| | | applications in the gaming |
| | | environment. |

IV. Profile Capability Codes

TABLE 20
Profile Capability Codes

| Subclass | Identifier (16 bit map) |
|---|---|
| HEADPHONE | 0x0001 |
| REMOTE CONTROL | 0x0002 |
| DISPLAY | 0x0004 |
| MENU CONTROL | 0x0008 |

By the foregoing example the inventors have provided details of the invention claimed herein but it will be understood by persons skilled in the art that this is exemplary only and various other configurations and implementations may be devised to obtain the advantages provided by the invention without departing from the scope of the invention claimed herein.

The individual electronic circuit elements and microprocessor functionality utilised in the foregoing described embodiment are well understood by those skilled in the art. It is to be understood by the reader that a variety of other implementations may be devised by skilled persons for substitution. Moreover, it will be readily understood by persons skilled in the art that various alternative configurations and types of circuit elements may be selected for use in place of those used for the embodiment described herein. It is also to be understood that the exemplary codes and definitions set out in the foregoing tables (under sections I, II, III and IV) may be modified (added to, reduced or otherwise modified), as appropriate, for a given application. The claimed invention herein is intended to encompass all such alternative implementations, substitutions and equivalents. Persons skilled in the field of electronic and communication design will be readily able to apply the present invention to an appropriate implementation for a given application.

Consequently, it is to be understood that the particular embodiment shown and described herein, by way of illustration, is not intended to limit the scope of the invention claimed by the inventors/assignee which is defined by the appended claims.

What is claimed is:

1. Electronic apparatus configured for management of data communications between at least two devices wirelessly connected in a wireless audio network, said data comprising audio signals and audio control commands and/or status information, wherein a first said device acts as a channel master and a second said device acts as a responding device associated with said channel master, each said device having a unique association identifier (AID) and an application profile identifying at least one class and one or more capabilities for said device, said electronic management apparatus being embodied in said devices and comprising profile negotiation means, said profile negotiation means comprising:
(i) means for communicating said application profiles for said devices between said first and second devices;
(ii) means for establishing at least one common application profile which is common to said devices; and,
(iii) means for designating a selected said common application profile (PIU) for use in associating said devices, and establishing interoperability between said devices, in said network.

2. Electronic apparatus according to claim 1 wherein said application profile for each said device further includes one or more optional capabilities of said device.

3. Electronic apparatus according to claim 2 wherein said optional capabilities comprise audio control commands.

4. Electronic apparatus according to claim 1 wherein said channel master is configured for transmitting said audio signal and said responding device is configured for receiving said audio signal.

5. Electronic apparatus according to claim 1 wherein said channel master is configured for transmitting and receiving said audio signal and said responding device is configured for receiving and transmitting said audio signal, respectively.

6. Electronic apparatus according to claim 1 and further comprising active association means for associating said first and second devices, said active association means being configured for detecting an active association trigger occurring concurrently in each said device and comprising means for exchanging between said devices their said AID's and said PIU, said association of said devices being performed before said data communications.

7. Electronic apparatus according to claim 6 wherein said network includes at least one additional wireless device configured to act as a passive device and be passively associated with said first device, said apparatus comprising passive association means configured for detecting a first passive association trigger in said associated second device and a concurrent second passive association trigger in said passive device and comprising means for communicating said AID of said first device to said passive device.

8. Electronic apparatus according to claim 4 wherein said first device is an audio source selected from a group of audio players comprising compact disc (CD) player, MP3 player and mini-disk player and said second device is an audio sink being one or both of a remote control and headphones.

9. Electronic apparatus according to claim 5 wherein said first device is a cell phone handset and said second device is a cell phone headset and said audio signals are bidirectional.

10. Electronic apparatus according to claim 1 wherein said first and second devices are separate items from, and connectable to, an audio source and an audio sink, respectively, said audio source configured for communicating said data to said first device and said first device configured for communicating said audio control commands and/or status information to said audio source and said audio sink configured for communicating said audio control commands and/or status information to said second device and said second device configured for communicating said data to said audio sink.

11. Electronic apparatus according to claim 10 wherein said first and second devices are plug-in devices configured to plug into said audio source and sink, respectively.

12. Electronic apparatus according to claim 11 wherein said audio source is selected from a group of audio players comprising compact disc (CD) player, MP3 player and mini-disk player.

13. Electronic apparatus configured for management of data communications between at least two devices wirelessly connected in a wireless audio network, said data comprising audio signals and audio control commands and/or status information, wherein a first said device acts as a channel master and a second said device acts as a responding device associated with said channel master, each said device having a unique association identifier (AID), said electronic management apparatus comprising channel selection means for selecting a channel for said communications, said channel selection means comprising:
(i) first selection means embodied in said first device and configured for scanning channels of said network for idle channels, establishing from said scanning an ordered selection of said channels (PCS) and communicating said ordered selection of channels (PCS) to said associated second device;
(ii) second selection means embodied in said first device and configured for selecting a first available channel from said ordered selection of channels (PCS) and transmitting beacon signals from said first device over said selected first available channel wherein said beacon signals comprise said unique association identifier (AID) of said first device; and,
(iii) third selection means embodied in said second device and configured for scanning channels in the order of said ordered selection of said channels (PCS) and identifying, for use by said second device, said selected channel of said first device from said scanning and detection of one said transmitted beacon having said unique association identifier (AID) of said first device.

14. Electronic apparatus according to claim 13 wherein said scanning comprises energy detection.

15. Electronic apparatus according to claim 14 wherein said ordered selection of channels (PCS) is ordered in subgroups according to channel quality, each channel of one said subgroup being considered to be of like quality to other said channels of said subgroup determined on the basis of a likelihood of said channels of said subgroup to experience interference and/or on the basis of a likelihood of said channels to be occupied.

16. Electronic apparatus according to claim 15 wherein the order of said channels of each said subgroup is randomized.

17. Electronic apparatus according to claim 13 wherein, upon pre-determined events, said first selection means re-establishes said ordered selection of said channels (PCS) and communicates the same to said associated device.

18. Electronic apparatus according to claim 13 and further comprising pre-emptive, hop-and-scan means embodied in said second device and configured for periodically scanning the next channel in said ordered selection of channels (PCS) after said selected channel of said first device, for determining next channel scan information therefrom and for communicating to said first device said next channel scan information, and said first device comprises means for removing said next channel from said ordered selection of channels (PCS) if said first device considers that said next channel is not idle based on said next channel scan information.

19. Electronic apparatus configured for management of data communications between at least two devices wirelessly connected in a wireless audio network, said data comprising audio signals and audio control commands and/or status information, wherein a first said device acts as a channel master and a second said device acts as a responding device associated with said channel master, said electronic apparatus comprising control and status interfaces configured for normalizing said audio control command and status information and communicating said normalized audio control and command and status information between said devices, for establishing interoperability between said devices, including those of said devices configured for communicating data streams which are incompatible prior to said normalizing.

20. Electronic apparatus according to claim 19 wherein said normalizing control and status interfaces comprise an analog key voltage interface (AKEY) configured for normalizing audio control command information.

21. Electronic apparatus according to claim 19 wherein said normalizing control and status interfaces comprise a digital serial messaging interface (ACSI) configured for normalizing audio control command information and status information.

22. Electronic apparatus according to claim 1 wherein said network is a digital audio network.

23. Electronic apparatus according to claim 13 wherein said network is a digital audio network.

24. A method for managing data communications between at least two devices wirelessly connected in a wireless audio network, said data comprising audio signals and audio control commands and/or status information, whereby a first said device acts as a channel master and a second said device acts as a responding device associated with said channel master, each said device having a unique association identifier (AID) and an application profile identifying at least one class and one or more capabilities for said device, said method comprising:
(i) communicating said application profiles for said devices between said first and second devices;
(ii) establishing at least one common application profile which is common to said devices; and,
(iii) designating a selected said common application profile (PIU) for use in associating said devices to establishing interoperability between said devices in said network.

25. A method according to claim 24 whereby association of said second device with said first device comprises detecting an active association trigger occurring concurrently in each said device and exchanging between said devices their said AID's and said PIU, before said data communications.

26. A method according to claim 25 whereby said network includes at least one additional wireless device, said method further comprising passively associating said additional device with said first device, said passive association comprising detecting a first passive association trigger in said associated second device and a concurrent second passive association trigger in said additional device and communicating said AID of said first device to said additional device.

27. A method according to claim 26, and further comprising selecting a channel for said communications, said channel selecting comprising:
(i) scanning channels of said network for idle channels, establishing from said scanning an ordered selection of said channels (PCS) and communicating said ordered selection of channels (PCS) to said associated second device;
(ii) selecting a first available channel from said ordered selection of channels (PCS) and transmitting beacon signals from said first device over said selected first available channel wherein said beacon signals comprise said unique association identifier (AID) of said first device; and,
(iii) scanning channels in the order of said ordered selection of said channels (PCS) and identifying, for use by said second device, said selected channel of said first device from said scanning and detection of one said transmitted beacon having said unique association identifier (AID) of said first device.

28. A method according to claim 27, and further comprising ordering said ordered selection of channels (PCS) in subgroups according to channel quality, each channel of one said subgroup being considered to be of like quality to other said channels of said subgroup determined on the basis of a likelihood of said channels of said subgroup to experience interference and/or on the basis of a likelihood of said channels to be occupied.

29. A method according to claim 28, and further comprising normalizing said audio control command and status information prior to communicating the same between said devices, for establishing interoperability between said devices, including those of said devices configured for communicating data streams which are incompatible prior to said normalizing.
